(19) United States
(12) Patent Application Publication
(10) Pub. No.: US 2014/0343910 A1
(43) Pub. Date: Nov. 20, 2014

(54) METHOD TO DETERMINE UNIT LOAD STABILITY

(71) Applicant: The Procter & Gamble Company, Cincinnati, OH (US)

(72) Inventors: Xiahua Zheng, Cincinnati, OH (US); Michael Timothy Looney, Blue Ash, OH (US); Leo T. Taske, Okeana, OH (US); Dean Larry Duval, Lebanon, OH (US)

(73) Assignee: The Procter & Gamble Company, Cincinnati, OH (US)

(21) Appl. No.: 13/896,363

(22) Filed: May 17, 2013

(51) Int. Cl. G06F 17/50

(52) U.S. Cl. CPC G06F 17/5009
USPC 703/6

(57) ABSTRACT

A method of using computer based models for determining the stability of a unit load is disclosed. The method includes representing one or more packages and a domain space. The method further includes configuring the packages within the domain space, containing the packages to form a unit load, simulating conditions on the unit load, and determining the stability of the unit load.

### FIELD

In general, the present disclosure relates to computer based models for determining the stability of a unit load. In particular, the present disclosure relates to methods of modeling the unit load on a pallet to determine the stable configuration for any given package or set of packages.

### BACKGROUND

Products of all shapes and sizes are transported on pallets. A pallet can contain a single item or hundreds of the same or different items making a unit load. The unit load on the pallets may be transported on ships, in planes, in trucks, and on forklifts to a customer from a product manufacturer. Each mode of transportation presents a set of forces that may be applied to the unit load on the pallet. For example, pallets with a unit load are often transported through a warehouse where they experience many forces before entering the shipping trucks. The forces may be created by acceleration, centrifugal movement, deceleration, and impact on the unit load. The pallet may experience these forces perpendicular to the ground or tilted on a forklift. Forces may also be experienced during the distribution cycle, including the transportation of the pallet with a unit load. The forces may cause products that are part of the unit load to shift on the pallet. This may alter the unit load such that the pallet and unit load does not meet the customer's requirements and can be rejected. Many customers require that a pallet with a unit load fit slots with set dimensions in warehouses. Dimensions may vary according to the customer. Shifts in the unit load on the pallet may often lead to unit loads and products being rejected for shipment. Excessive forces or the summation of multiple forces may cause items to shift on the pallet, leading to spills or excessive deformation of the packages. Depending on the damage caused to the spilled or deformed packages, the packages may no longer be suitable for shipment or meet the product manufacturer's desired specifications for shelf appearance.

Configuring pallets and stacking pallets with unit loads traditionally rely on creating flat surfaces and wrapping the unit load on the pallet. However, this does not wholly prevent items from shifting, particularly when exposed to different forces. This is particularly true for lighter weight packages, wherein the different forces may have a greater impact on the packages. Also, one may choose to ship a pallet with various packages of different geometries versus a pallet with uniform geometries.

As a result, it would be beneficial to simulate a pallet with a unit load to test for different item configurations allowing one to determine the stability of the unit load when exposed to various forces.

### SUMMARY

A method of simulation, wherein the method includes representing a plurality of packages and a domain space. The method further includes configuring the plurality of packages within the domain space. The method further includes containing the plurality of packages to create a unit load, simulating conditions on the unit load, and determining the stability of the unit load.

A method of simulation, wherein the method includes representing a plurality of packages and a domain space. The method further includes configuring the plurality of packages within the domain space, simulating conditions on the plurality of packages as a unit load, and determining the stability of a package.

### BRIEF DESCRIPTION OF THE DRAWINGS

FIG. 1 is a chart illustrating a method for modeling the stability of a unit load when exposed to various forces.

FIG. 2 is a chart illustrating a computer system.

FIGS. 3A-K are perspective views of different potential primary packages.

FIG. 4 is a perspective view of a secondary package.

FIG. 5 is a perspective view of a domain space including a pallet as a lower surface.

FIG. 6 is a perspective view of a pallet with configured packages.

FIG. 7 is a perspective view of a pallet with configured packages.

FIG. 8 is a perspective view of a pallet with configured packages.

FIG. 9 is a perspective view of a pallet with a unit load.

FIG. 10 is a perspective view of a pallet with a unit load.

FIG. 11 is a perspective view of a pallet with a unit load.

FIG. 12 is a perspective view of two pallets with one placed on the other.

FIG. 13 is a perspective view of a unit load that overhangs the pallet.

### DETAILED DESCRIPTION

As used herein, “absorbent article” refers to a device or implement that has the capacity to uptake and to release a fluid. An absorbent article can receive, contain, and absorb bodily exudates (e.g. urine, menses, feces, etc.). Absorbent articles include absorbent articles placed inside the body, in particular tampons and the like. Other non-limiting examples of absorbent articles include absorbent articles worn next to the human body, in particular sanitary napkins, panti-liners, interlabial pads, diapers, pull-on diapers, training pants, incontinence products, toilet tissue, paper towels, facial tissue, wound dressings, and the like.

As used herein, “boundary conditions” are defined variables that represent physical factors acting within a computer based model. Examples of boundary conditions include forces, pressures, velocities, and other physical factors. Each boundary condition may be assigned a particular magnitude, direction, and location within the model. These values may be determined by observing, measuring, analyzing, and estimating real world physical factors. Computer based models may also include one or more boundary conditions that differ from real world physical factors to account for inherent limitations in the models and to more accurately represent the overall physical behaviors of real world things, as will be understood by one of ordinary skill in the art. Boundary conditions may act on the model in various ways, to move, constrain, and deform one or more parts in the model.

As used herein, “good” or “goods” relates to any commercial items that may be transported on a pallet. Goods are tangible, movable, and generally not consumed at the same time they are produced. Goods include, without limitation, appliances, auto parts, beverages including alcoholic beverages and non-alcoholic beverages, business equipment, cigarettes, confectioners, dairy products, electronic equipment, farm products, food, home furnishings and fixtures, housewares and accessories, meat products, office supplies, packaging and containers, laundry detergent, paper and paper products, personal products, photographic equipment and supplies, processed and packaged goods, recreational goods, rubber and plastics, sporting goods, textiles (clothing, footwear, and accessories), and toys.

As used herein, a “package” relates to a container in which a good is packed for storage or transportation. A package may be a primary package or a secondary package.

As used herein, a “primary package” relates to a package that contains one or more of a good or product.

As used herein, a “secondary package” relates to a package that contains one or more of a primary package.

As used herein, “stability” relates to the package configuration maintaining the desired standard for that set of packages after a simulation. The desired standard may equal no shifting beyond the domain space, a set limit for shifting within the domain space, a set limit for allowable shifting beyond the domain space, or combinations thereof. This may represent minimal to no overhang and minimal to no shifting of packages and of a unit load within the domain space. The boundaries of stability may be defined according to a particular customer such that the pallet with a unit load meets that customer's specific requirements, such as, for example, dimensions such that the pallet with a unit load does not extend beyond a set footprint or the borders of the domain space in any direction, height requirement, or ability to maintain its shape when exposed to certain forces.

As used herein, “unit load” relates to a set of primary packages, secondary packages, or a combination of primary packages and secondary packages located within a domain space. The unit load may be contained or uncontained.

Values disclosed herein as ends of ranges are not to be understood as being strictly limited to the exact numerical values recited. Instead, unless otherwise specified, each numerical range is intended to mean both the recited values and any integers within the range. For example, a range disclosed as “1 to 10” is intended to mean “1, 2, 3, 4, 5, 6, 7, 8, 9, and 10.”

The present disclosure includes methods of simulating conditions on a unit load to determine the stability of the unit load. The unit load may comprise a package or a plurality of packages within a domain space. The one or more packages may be contained. The domain space may comprise a pallet and the volumetric space directly above the pallet. Alternatively, the domain space may not comprise a pallet. The present disclosure may assist in predicting whether or not the packages on a pallet that form the unit load are stable in their present configuration. The present disclosure also assists in predicting the impact of the distribution cycle on a particular package within the unit load and on the unit load. As a result, unit loads comprising configured packages may be evaluated and modified as computer based models before they are tested as real world things or a real unit load is put together.

Computer aided engineering (CAE) is a broad area of applied science in which technologists use software to develop computer based models that represent real world things. The models can be transformed to provide information about the physical behavior of those real world things, under certain conditions and over particular periods of time. With CAE, the interactions of the computer based models are referred to as simulations. Sometimes the real world things are referred to as a problem and the computer based model is referred to as a solution.

Commercially available software can be used to conduct CAE. ABAQUS, LS-DYNA, Fluent, from ANSYS, Inc. in Canonsburg, Pa., Flow3D, from Flow Science, Inc. in Santa Fe, N. Mex., and FeFlow from DHI-WASY in Berlin, Germany are examples of commercially available CFD software. Alternatively, CAE software can be written as custom software or may be open source code software, for example, OpenFOAM. CAE software can be run on computer hardware, such as a personal computer, a minicomputer, a cluster of computers, a mainframe, a supercomputer, or any other kind of machine on which program instructions can execute to perform CAE functions.

CAE models can represent a number of real world things, such as a unit load, a pallet, or the individual packages on a pallet.

CAE can be used to design, simulate, and evaluate all kinds of pallet configurations, materials, and structures, as well as their performance characteristics, such as stability.

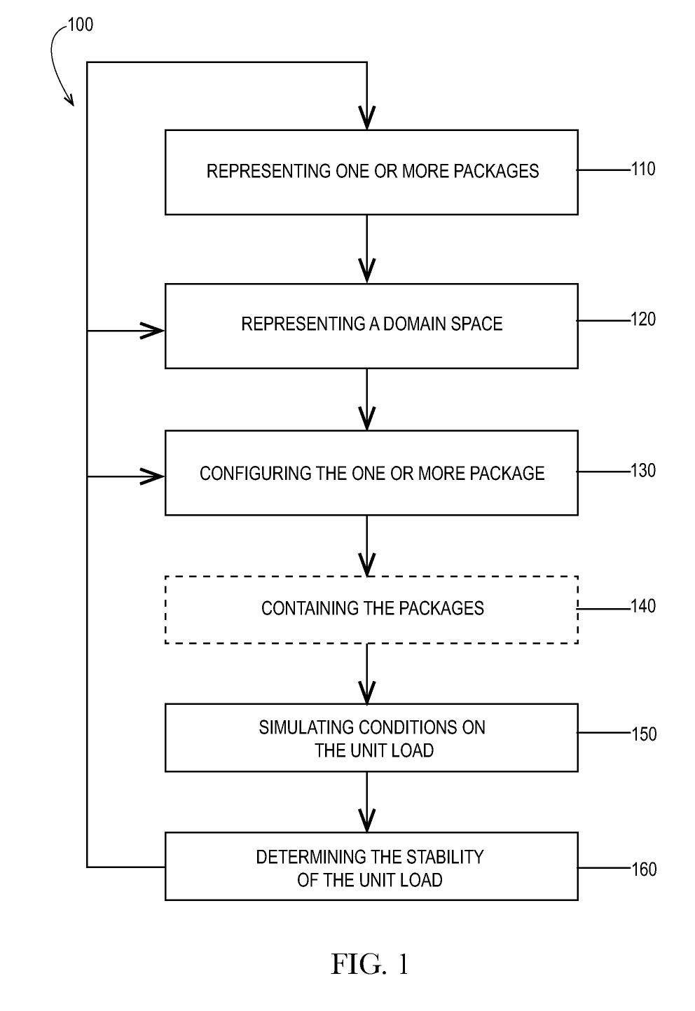

FIG. 1 is a chart illustrating a method 100 of steps 110-160 for using computer based models to determine the stability of a unit load. Although the steps 110-160 are described in numerical order in the present disclosure, some or all of these steps can be performed in other orders, and/or at overlapping times, and/or at the same time, as will be understood by one of ordinary skill in the art.

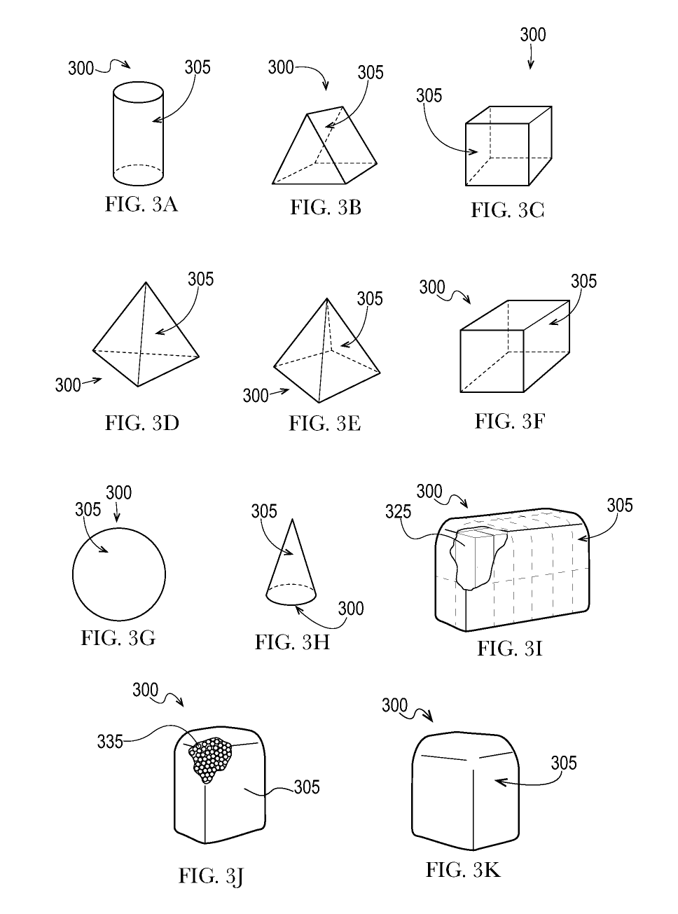

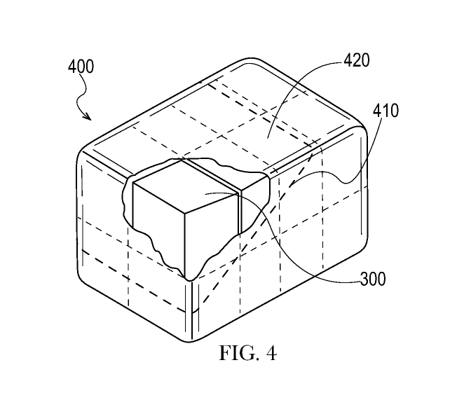

The method 100 includes a first step 110 of representing one or more packages or a plurality of packages. A package may be a primary package or a secondary package. The packages may be a plurality of primary packages, a plurality of secondary packages, and combinations thereof. The primary package may be combined with other primary packages to form a secondary package. The secondary package may be comprised of different primary packages containing different goods in each package. The primary package or secondary package may be created in connection with FIGS. 3A-K and FIG. 4.

Representing one or more packages may include inputting parameters related to the individual packages, such as, for example, the dimensions of the package and the weight of the package.

Representing one or more packages may include calculating the center of mass for one or more of the packages and the center of mass for a portion of a package. The center of mass may be determined for any portion of a package, such as, for example, a portion of a primary package, a primary package, a portion of a secondary package, and a secondary package.

Representing one or more packages may include inputting parameters related to the good(s) within the primary package, such as, for example, the size of the good(s), the shape of the good(s), and the fracturability of the good(s).

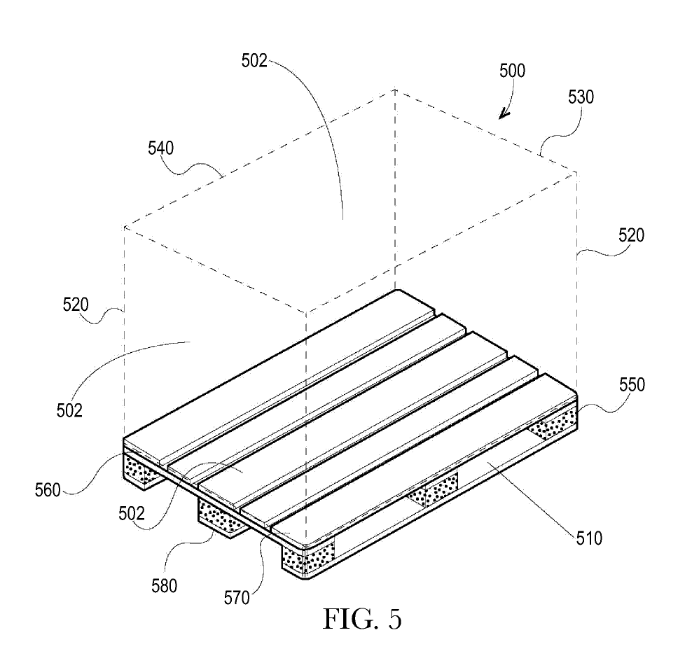

The method 100 includes a second step 120 of representing a domain space. The domain space may have a flat lower surface. The lower surface may be a virtual structure, such as, for example, a pallet. The model of the domain space and the pallet may be created as described in connection with FIGS. 5-13. The domain space has a height, length, and width. The length and width of the domain space may be based on the pallet. A corner of the domain space may be used as a reference point to determine the location of packages within the domain space and in relation to the domain space.

Representing the domain space may include selecting one or more reference points within the domain space or along the perimeter of the domain space, such as, for example, a corner of the domain space, a point on the outer surface of the domain space, or a point within the domain space. The virtual structure may be a reference point constraining the bottom of the packages within the domain space.

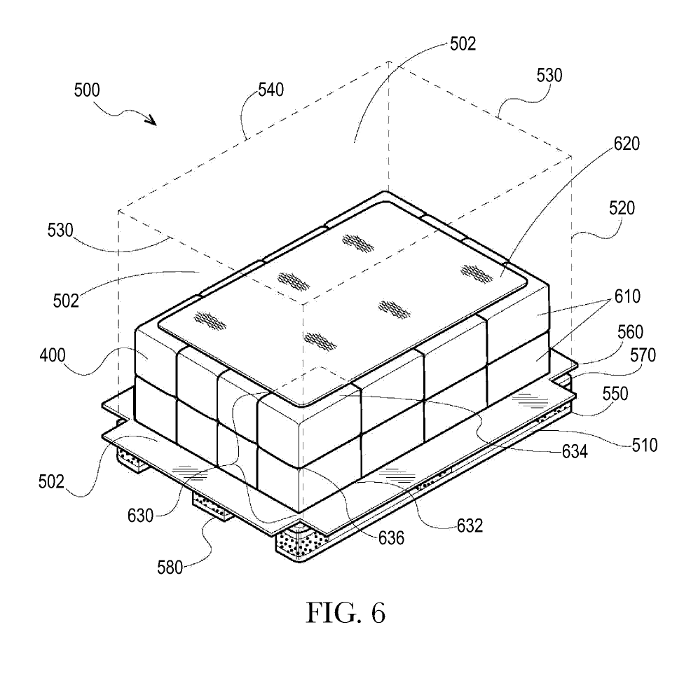

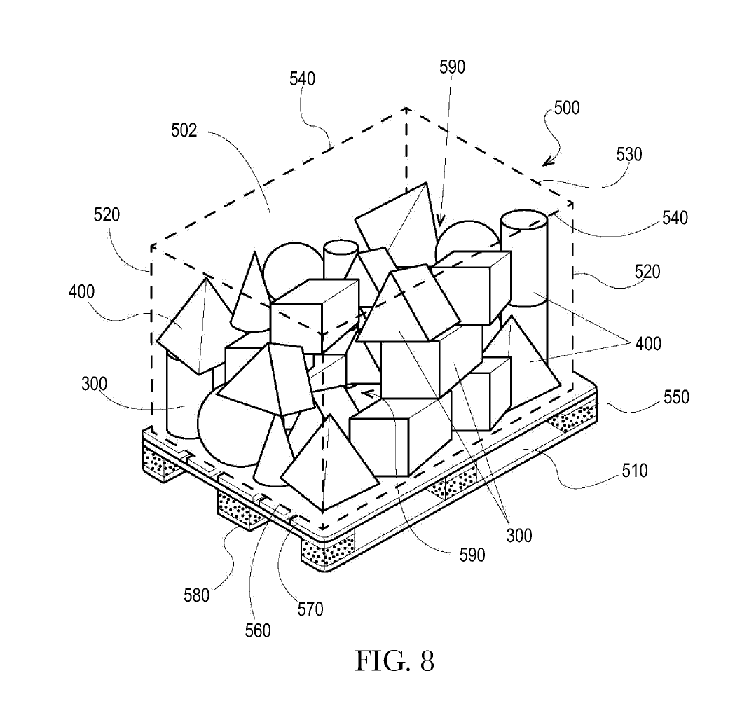

The method 100 includes a third step 130 of configuring the one or more packages within the domain space. The packages may be primary packages, secondary packages, and combinations thereof. Configuring the packages may include fitting the primary and secondary packages within the domain space which may consist of a footprint of the pallet and a chosen total height. The packages may be configured such that the packages are aligned horizontally forming a layer within the domain space as shown in FIGS. 6-7 and FIGS. 9-13. The packages may be configured such that the packages are aligned vertically forming a stack within the domain space as shown in FIG. 6. Alternatively, the packages may be randomly oriented within the domain space as shown in FIG. 8.

Configuring the packages may include determining the center of mass and location coordinates for each package after the package is located in the domain space. Configuring the packages may also include determining the center of mass for a portion of the domain space comprising a plurality of packages and determining the center of mass for the domain space comprising all the packages. Configuring the packages may include determining the location of a package in relation to one or more reference points. Configuring the packages may include determining the location of a package in relation to the center of mass of all the packages within the domain space as a group. It shall be understood by one of ordinary skill in the art that configuring the one or more packages may comprise configuring portions of the domain space in different manners, such as, for example, a portion of the domain space may be configured in layers while another portion of the domain space may be configured in a random orientation.

The domain space may have multiple layers. The primary and secondary packages may be configured to interlock with other primary and secondary packages within a layer or between separate layers. The layer may also comprise primary packages enabled to interlock with secondary packages and secondary packages that interlock with primary packages. Interlocking between packages may occur between packages comprising different shapes and sizes. The interlocking packages may comprise different goods.

The method 100 includes an optional fourth step 140 of containing the packages within the domain space to create a unit load. The packages may be contained by a restraining element, such as, for example, a wrapping material, an enclosing panel, one or more corner posts, a tray and hood, a strap, and combinations thereof. Containing the packages may include determining the deformation of the unit load once the packages are contained.

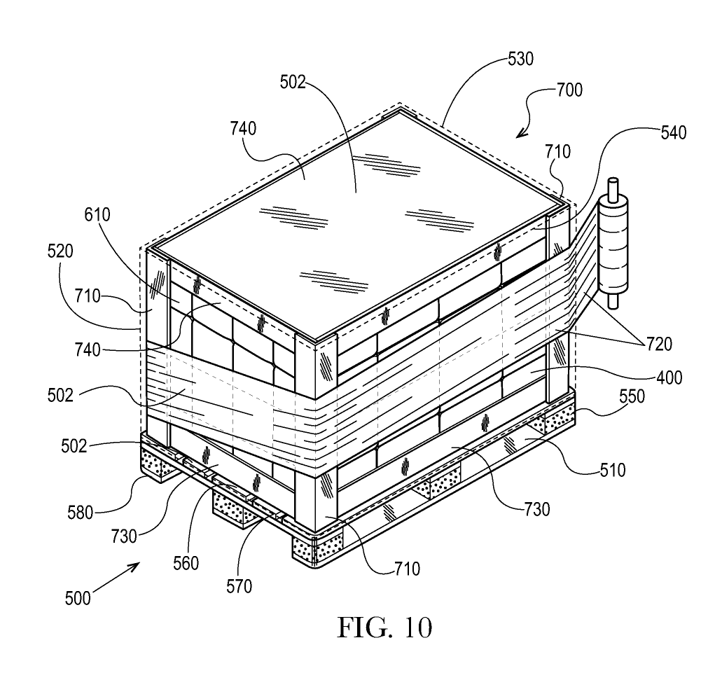

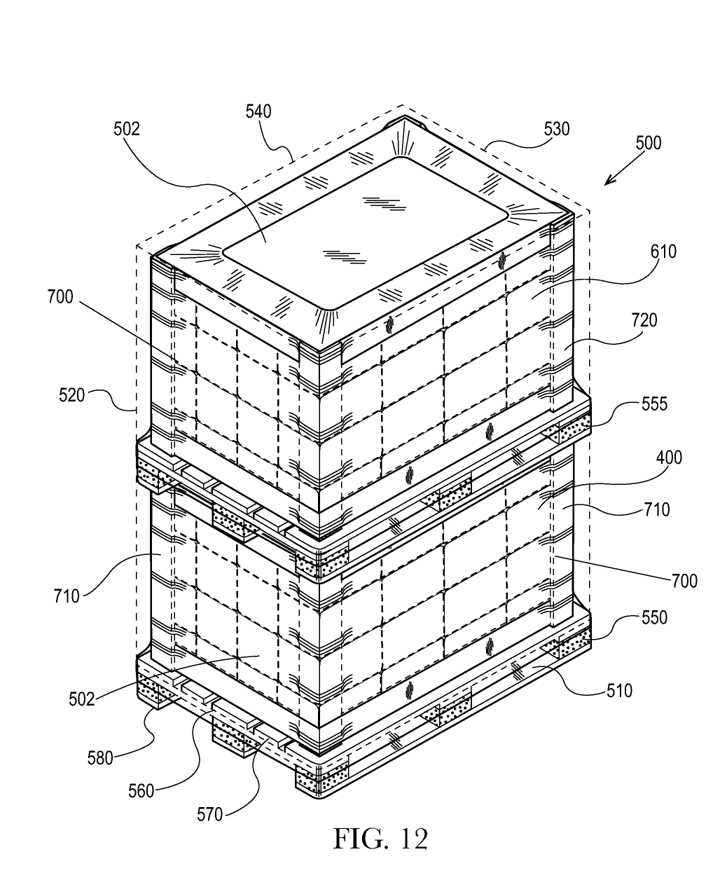

The packages may be wrapped by any suitable material such as, for example, shrink wrap, non-shrinking plastic film, stretch film, and paper, as shown in FIGS. 10 and 12. Containing the packages within the domain space may include inputting parameters for the wrapping material, such as, for example, initial modulus, reloading modulus, yielding stress, failure strain, and combinations thereof. Wrapping the unit load may include wrapping the unit load in different configurations, such as, for example, from top to bottom, from bottom to top, from center to top, and from center to bottom. Alternatively, the packages may form a unit load without being contained.

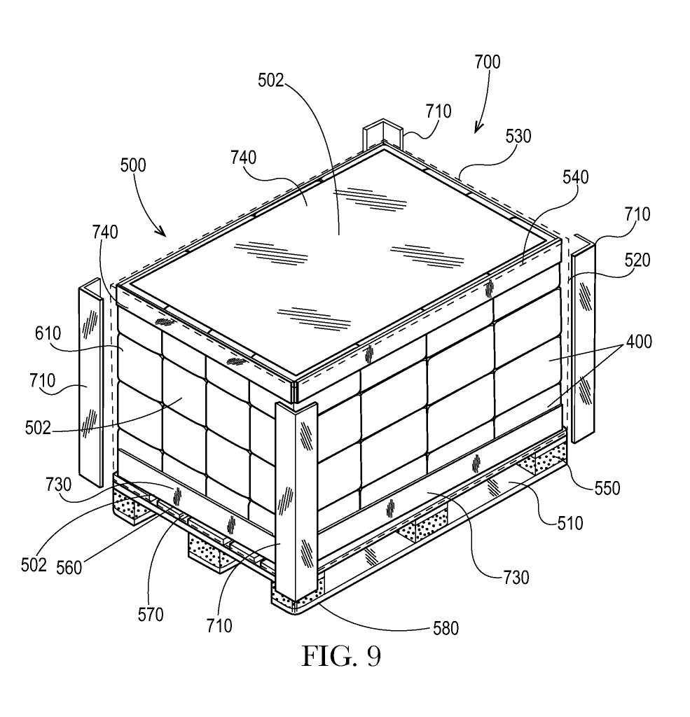

As shown in FIGS. 9-10 and FIG. 12, corner posts may be used to contain the packages. The corner posts may be combined with a tray and hood, with the wrapping, and combinations thereof.

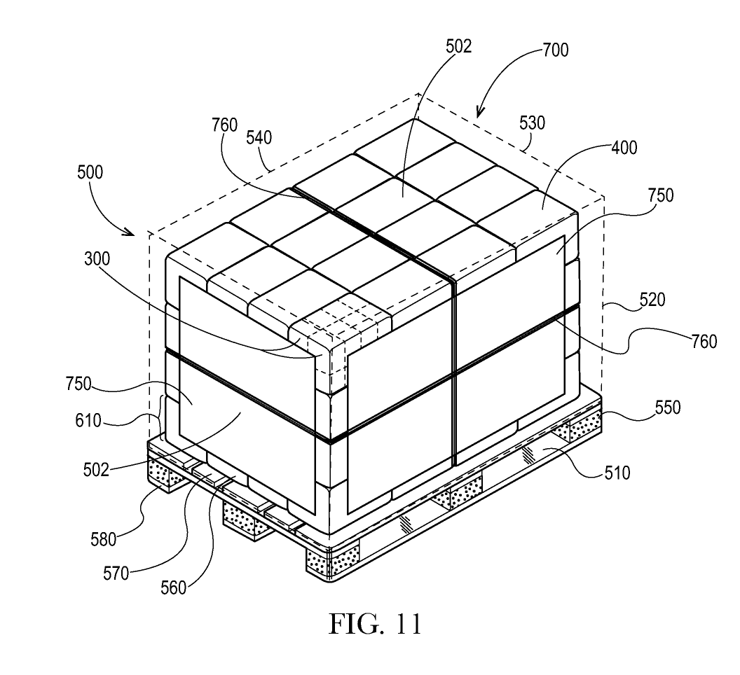

As shown in FIG. 11, panels may be used to contain the packages. Panels used to enclose the unit load may be made of any suitable material such as, for example, cardboard and plastic.

As shown in FIG. 11, straps may be used to contain the packages by going around the perimeter of the unit load. Straps may be made of any suitable material such as, for example, plastic, metal, and cardboard. A strap may be heat sealed, glued, or tied to itself to enclose the perimeter of the unit load.

The method 100 further includes a fifth step 150 of simulating conditions on the unit load by running a simulation of one or more forces on the unit load. Simulating conditions on the unit load may include transforming the unit load, the individual primary packages, and the secondary packages.

The simulation of the unit load may be run on software such as, for example ABAQUS, LS-DYNA, GOMA Sandia National Lab code, Flow3D®, or FEFLOW. FLOW-3D® is a commercially available multi-physics software code developed and distributed by Flow Science, Inc., Santa Fe, N. Mex. FLOW-3D® may be run on a desktop computer or a computer having a more advanced operating system, such as UNIX.

The simulation may be run according to parameters, such as, for example, the height of the unit load, the overall size of the unit load, the weight of the unit load, the center of mass of the products within the domain space, and combinations thereof.

Simulating conditions on the unit load may include inputting conditions, such as, for example, a magnitude of a force, a direction of a force, the number of times a unit load is exposed to a force, a force pattern, the angle of the unit load when being exposed to a force, the location of the unit load exposed to the force, and combinations thereof.

The simulation may be run to simulate real world events. The simulation may simulate various forces on the unit load created by, for example, acceleration, centrifugal movement, deceleration, g-forces, and impact on the unit load. The domain space lower surface may be at an angle during different parts of the simulation. The angle may be any angle capable of being achieved by a forklift, such as, for example, between zero degrees and forty five degrees. For example, the domain space lower surface may be at zero degrees during a part of the simulation, twenty degrees during another part of the simulation, and back to zero degrees during another part of the simulation.

The simulation may be run to simulate stress forces over time on the unit load, secondary packages, and primary packages such as, for example, relaxation of the materials of the packages and creep of the materials of the packages on the pallet.

The simulation may be run on multiple pallets or a unit load comprising two pallets as shown in FIG. 12 to determine the stability of both unit loads as one unit and to determine the impact of the upper pallet on the primary packages and on the secondary packages of the lower pallet.

The output of the model may be controlled based on the parameters used for the primary package properties, the secondary package properties, the configuration of the primary packages, the configuration of the secondary packages, and the simulated forces. Parameters may include the coefficient of friction based on the adjacent materials, the friction between two or more primary packages, the friction between two or more secondary packages, the friction between the pallet and the packages, the friction between the containment structure and the packages, and the friction between the packages and a tie sheet. Frictional forces may include static forces and dynamic behavior forces.

One or more computer based CAE models may include one or more defined interactions that differ from real world physical interactions, in order to account for inherent limitations in the models and to more accurately represent the overall physical behaviors of real world things, as will be understood by one of ordinary skill in the art.

The method 100 includes a sixth step 160 of determining the stability of the unit load. Determining the stability of the unit load may comprise determining the stability of the packages. Determining the stability of the unit load may comprise determining a shift in the location of the unit load, determining a shift in the location of a package, determining overhang for the unit load beyond the domain space, and determining overhang for a package beyond the domain space.

A shift in the location of the unit load may be calculated by determining the location of the center of mass of the unit load and using the distance equation between the location of the center of mass and the initial location of the center of mass. The distance equation may also be used to determine a distance change in relation to the one or more reference points.

Determining the stability of the unit load may comprise determining a shift in location for the center of mass for a package or a portion of a package in relation to the initial center of mass for the package or the portion of the package, in relation to the initial center of mass of the unit load, in relation to the one or more reference points, or in relation to a combination thereof.

Determining the stability of the unit load may include determining the amount of overhang of the unit load in comparison to the domain space lower surface in any one direction, at any point along each side of the domain space along a vertical plane.

Determining the stability of the unit load may include determining the center of mass of the unit load after simulating conditions on the unit load. The center of mass may be compared to the center of mass determined before simulating the conditions or to one or more of the reference points.

Determining the stability of the unit load may include determining the amount of overhang of a package in comparison to the domain space in any one direction at any point along each side of the domain space along a vertical plane. Determining the amount of overhang may be done by calculating the shift in the center of mass of a package and comparing the location before simulating conditions to determine if any portions of the package are outside of the domain space.

Determining the amount of overhang of products in comparison to the pallet footprint may include calculating the final center of mass location for each package and comparing the shift in location of the center of mass to the location of the initial center of mass for the package. The final center of mass location for each package may also be compared to the overall unit load's final center of mass location to determine any additional shifting done by an individual primary or secondary package beyond the overall unit load.

Determining the stability of the one or more packages may include, for example, determining the deformation of the package due to a second unit load on the unit load and determining the pressure on the package due to the simulation. Determining the stability of the one or more packages may include, for example, determining the impact of the simulation on the good(s) within the primary packages on the pallet or determining buckling by the individual packages.

Depending on the determined stability of the unit load, the simulation may be run again providing different primary or secondary packages, configuring the same or different packages in a different configuration, containing the packages using a different method, material, or combination of both, and combinations thereof. The simulation may be run until the unit load is stable within the domain space.

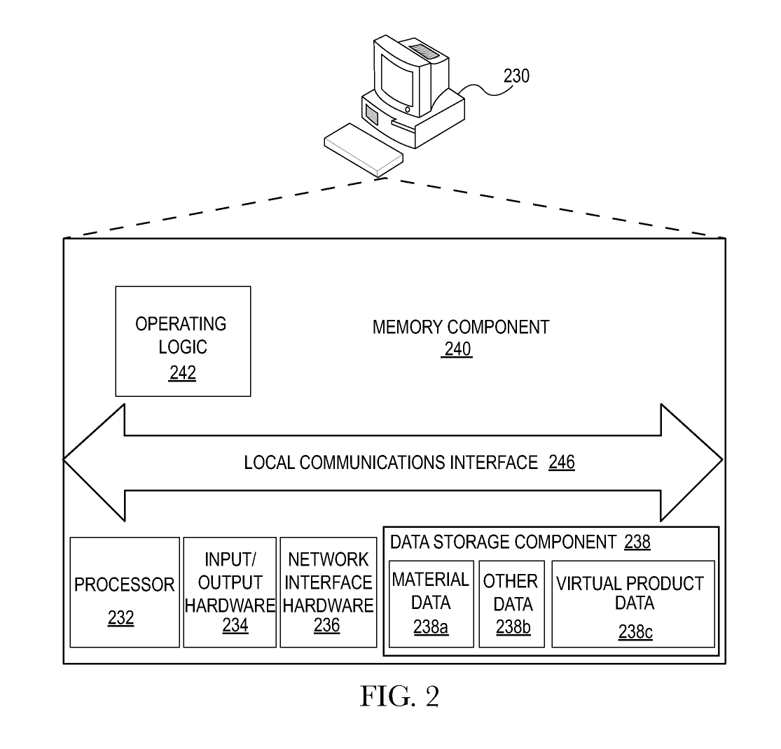

FIG. 2 depicts a computing device 230 according to systems and methods disclosed herein. The computing device 230 includes a processor 232, input/output hardware 234, network interface hardware 236, a data storage component 238 (which stores material data 238a, other data 238b, and virtual product data 238c), and a memory component 240. The computing device 230 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 230 and/or external to the computing device 230.

The memory component 240 may be configured to store operating logic 242 that may be embodied as a computer program, firmware, and/or hardware, as an example. The operating logic 242 may include an operating system, web hosting logic, and/or other software for managing components of the computing device 230. A local communications interface 246 is also included in FIG. 2 and may be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

It should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. The data storage component 238 may be a peripheral device external to the computing device 230.

It should be understood that the computing device components illustrated in FIG. 2 are merely exemplary and are not intended to limit the scope of this disclosure. While the components in FIG. 2 are illustrated as residing within the computing device 230, this is merely an example. In some systems and methods, one or more of the components may reside external to the computing device 230. The simulation, code utilized to run the simulation, or code utilized to represent any part of the simulation may be read from a computer readable media separate from the computer. It should also be understood that, while the computing device 230 in FIG. 2 is illustrated as a single system, this is merely an example. In some systems and methods, the modeling functionality is implemented separately from the prediction functionality, which may be implemented with separate hardware, software, and/or firmware.

FIGS. 3A-K show a primary package 300 in multiple geometries. The primary package 300 may contain different goods such as, for example, absorbent articles. As shown in FIGS. 3A-K, the primary package 300 has a void space 305. The void space 305 is the volume within the primary package 300 that may contain the good(s). As shown in FIGS. 3I and 3J, goods in the form of consumer units 325 and particles 335 may be placed within the void space 305.

The primary package 300 may comprise the shape of any one of the geometries shown in FIGS. 3A-H. The primary package 300 may vary in any dimension, such as, for example, height, length, and width. The primary package 300 may be of any suitable shape such as, for example, a square, a rectangle, a pyramid, or a cylinder. The primary package 300 may be an irregular shape, such as, for example, FIGS. 3I-K. The primary package 300 may comprise a combination of the shapes shown in FIG. 3A-H, such as, for example a cone connected to a portion of a sphere. It shall be understood by one of ordinary skill in the art that the void space may be calculated by adding the void space of the portions or whole shapes that are added together to make a new shape for the primary package 300.

The good contained in the primary package 300 may comprise one part or many parts. The primary package 300 may contain a continuous amount of a good or a plurality of individual consumer units of a good. As shown in FIG. 3I, the primary package 300 may contain a consumer unit 325, such as, for example, an absorbent article. As shown in FIG. 3J, the good may be in the form of particles 335, such as, for example, pet food including pet kibble, livestock feed, sand, soil, sugar, salt, or grains. The good may be in the form of individual units, such as, for example, gumballs. The good may be deformable, such as, for example, absorbent articles and paper goods. The good may be fracturable.

For absorbent articles, a primary package 300 may usually contain from about 4 to 60 consumer units 325, with most products being sold with a count of between 8 and 28 absorbent articles. For absorbent articles, the primary package 300 usually has a generally cubic shape. The primary package 300 may be made of a plastic film, as is usual in the trade. Absorbent articles are normally relatively soft and deformable and may suffer during transport and storage if they are not properly protected.

The primary package 300 may be defined by any one of multiple geometries. The multiple geometries may be subdivided into elements or portions of the whole geometry. A user may input parameters for the elements such as density, weight, stiffness, and a center of mass. Individual packages may have differing stiffness based on the geometric orientation of the package. Finite element analysis may be used to determine the center of mass for a portion of the primary package 300 or the entire primary package 300.

FIG. 4 shows a secondary package 400 containing a plurality of primary packages 300. The shape of the secondary package 400 may be the same or different than the primary packages 300 contained therein. The secondary package 400 is made of any suitable material, such as, for example, cardboard or plastic. The secondary package 400 may be deformable. The secondary package 400 may not protect its content from crushing in normal storage and transport conditions. The secondary package 400 may be light-weight, cheap and recyclable, and may be made of any flexible material common in the field of packaging, such as, for example, plastic films. A secondary package made of a plastic film may be made by a flow wrap process. A secondary package may be made by other processes, such as, for example, a shrink film or film sleeve process.

A means of opening the secondary package 400, such as, for example, a pre-ruptured line 410 may be present to facilitate opening the secondary package 400. The pre-ruptured line 410 may define a removable surface 420 on the secondary package 400. The surface 420 may represent from about 10% to about 45% or from about 20% to about 35% of the overall surface of the secondary package 400. The secondary package 400 may be, for example, placed directly on the shelf of a retailer with the surface 420 removed. The remaining part of the secondary package 400 then holds the primary packages 300 together while the removed surface 420 allows easy removal of the primary packages 300 contained therein. The pre-ruptured line 410 may extend across four sides of the secondary package 400. In an exemplary configuration, for each side of the secondary package where the pre-ruptured line is present, the removable surface for that side may not represent more than three quarters of the surface of that side, so that sufficient material remains in order to keep the primary packages 300 in a stable condition.

The computer based model may be created as described below, with general references to a computer based model of the primary packages and the secondary packages. A computer based model that represents the primary packages and the secondary packages may be created by providing dimensions and material properties to the modeling software and by generating a mesh for the packages using meshing software. A mesh is a collection of small, connected polygon shapes that defines the set of discrete elements in a CAE computer based model. The type of mesh and/or the size of elements may be controlled with user inputs into the meshing software, as will be understood by one of ordinary skill in the art.

A computer based model of the primary packages and the secondary packages may be created with dimensions that are similar to, or the same as, dimensions that represent parts of a real world primary package and a real world secondary package. These dimensions may be determined by measuring actual samples, by using known values, or by estimating values. Alternatively, a model of a primary package, a secondary package, and a model of a primary package and a secondary package may be configured with dimensions that do not represent a real world package. For example, a model of a primary package or a secondary package may represent a new variation of a real world package or may represent an entirely new package. In these examples, dimensions for the model may be determined by varying actual or known values, by estimating values, or by generating new values. The model may be created by putting values for the dimensions of parts of the package into the modeling software.

The computer based model of the primary packages and the secondary packages may be created with material properties that are similar to, or the same as, material properties that represent a real world primary package or a real world secondary package. These material properties may be determined by measuring actual samples, by using known values, or by estimating values. Alternatively, a model of a primary package or a secondary package may be configured with material properties that do not represent a real world package. For example, a model of a primary package or a secondary package may represent a new variation of a real world package or may represent an entirely new package. In these examples, material properties for the model may be determined by varying actual or known values, by estimating values, or by generating new values. The computer based model of the package may be created with more than one type of a virtual good.

The computer based model of the primary packages or the secondary packages may be created with a mesh for the parts of the primary packages or the secondary packages. An external surface of a primary package or a secondary package may be created by using shell elements, such as linear triangular elements (also known as S3R elements) with an element size of about 1.5 millimeters. Also, a material may be created by using solid elements, such as linear hexahedral elements (also known as C3D8R elements) with an element size of about 1.5 millimeters. For clarity, the mesh is not illustrated in FIGS. 3A-K and 4.

FIG. 5 represents a domain space 500. The domain space 500 has a height 520, a width 530, and a length 540. The domain space 500 has a flat lower surface 560. One or more reference points 502 may be chosen within the domain space 500 or along the perimeter of the domain space 500. The flat lower surface 560 may be a top surface 570 of a pallet 550, which may be any standard pallet normally used for transporting goods. The pallet 550 further comprises a bottom surface 580. The pallet 550 may be made of wood or plastic material, or other general materials that are sufficiently resistant and cheap for the intended use. The size and properties of pallets are normally standardized in a given region. For example, in Europe, a standard pallet has a surface of about 800 mm×1200 mm and a height of 150 mm. The present disclosure is not limited to a specific type of pallet. Pallets normally comprise grooves 510 for allowing manipulation of the unit load by a fork lift.

The domain space length 540 and width 530 may equal the dimensions of the pallet top surface 570. Alternatively, the domain space length 540 and width 530 may be less than the dimensions of the pallet top surface 570. In an alternative configuration, the domain space length 540 and width 530 may be greater than the dimensions of the pallet top surface 570.

The computer based model may be created as described below, with general references to a computer based model of a pallet. A computer based model that represents a pallet for a good may be created by providing dimensions and material properties to modeling software and by generating a mesh for the pallet using meshing software.

A computer based model of a pallet may be created with dimensions that are similar to, or the same as, dimensions that represent parts of a real world pallet. These dimensions may be determined by measuring actual samples, by using known values, or by estimating values. Alternatively, a model of a pallet may be configured with dimensions that do not represent a real world pallet. For example, a model of a pallet may represent a new variation of a real world pallet or may represent an entirely new pallet. In these examples, dimensions for the model may be determined by varying actual or known values, by estimating values, or by generating new values. The model may be created by putting values for the dimensions of parts of the pallet into the modeling software.

The computer based model of the pallet may be created with material properties that are similar to, or the same as, material properties that represent a real world pallet. These material properties may be determined by measuring actual samples, by using known values, or by estimating values. Alternatively, a model of a pallet may be configured with material properties that do not represent a real world pallet. For example, a model of a pallet may represent a new variation of a real world pallet or may represent an entirely new pallet. In these examples, material properties for the model may be determined by varying actual or known values, by estimating values, or by generating new values.

The computer based model of the pallet may be created with a mesh for the parts of the pallet. An external surface of a pallet may be created by using shell elements, such as linear triangular elements (also known as S3R elements) with an element size of about 1.5 millimeters. Also, a material may be created by using solid elements, such as linear hexahedral elements (also known as C3D8R elements) with an element size of about 1.5 millimeters. For clarity, the mesh is not illustrated in the embodiment of FIG. 5.

As shown on FIGS. 6-13, the domain space 500 has a height 520, a width 530, and a length 540. The domain space has a flat lower surface 560. One or more reference points 502 may be chosen within the domain space 500 or along the perimeter of the domain space 500. The flat lower surface 560 may be a top surface 570 of a pallet 550. The pallet 550 has a bottom surface 580 and may have grooves 510 for allowing manipulation of the unit load by a fork lift.

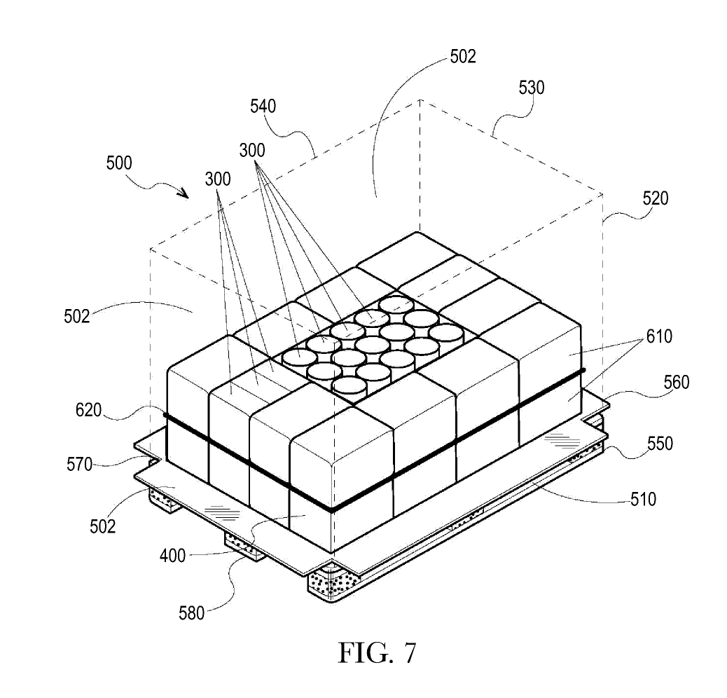

As shown in FIGS. 6-13, secondary packages 400 may be configured within the domain space 500. As shown in FIGS. 7, 8, and 11, primary packages 300 may be configured within the domain space 500.

As shown in FIGS. 6-7, and 9-13, the primary packages 300 and/or secondary packages 400 may be configured to form one or more layers 610. The primary packages 300 and/or secondary packages 400 may be configured to interlock within a layer 610. As shown in FIG. 6, the configuration layers 610 may form a stack 630. The stack 630 may comprise a bottom edge 632, defined by the periphery of the first, bottommost layer of secondary packages 400, and a top edge 634 defined by the periphery of the last, uppermost layer of secondary packages 400. The stack comprises a plurality of vertical corners 636 between the bottom edge 632 and top edge 634. Normally, the stack 630 may have a generally constant rectangular cross-section in the horizontal plane, and the bottom edge 632 and top edge 634 of the stack may have four sides, and four vertical corners 636.

As shown in FIGS. 6 and 7, a tiesheet 620 may be placed between any two of the layers 610 or between the pallet 550 and the layers 610. As shown in FIG. 7, a layer 610 may comprise different primary packages 300 and a combination of both primary packages 300 and secondary packages 400.

Alternatively, as shown in FIG. 8, the primary packages 300 and the secondary packages 400 may be configured within the domain space 500 in a random order. The simulation may calculate the volume of the domain space 500, the total volume of all the individual primary packages 300 and the secondary packages 400, and orient the packages to fit within the domain space 500. The configuration may place packages in any orientation within the domain space 500. Further, one or more gaps 590 may exist between the packages and between the perimeter of the domain space 500 and the packages. The one or more gaps 590 may be added to determine the percentage of open space within the domain space 500. The percentage of open space should be minimized within the domain space to allow for more primary packages 300, secondary packages 400, and combinations thereof. For example, the percentage of open space may be less than 25% of the volume of the domain space 500, such as, for example, 20%, 15%, 10%, 5%, 4%, 3%, 2% or 1%.

FIG. 9 shows a domain space 500 with a pallet 550 abutting the domain space 500. The domain space 500 has a height 520, a length 540, and a width 530. The domain space 500 has a flat lower surface 560. The pallet 550 has grooves 510 for allowing manipulation of the unit load by a fork lift. The domain space 500 is configured with secondary packages 400. The secondary packages 400 are contained by corner posts 710, a tray 730, and a hood 740 to form a unit load 700.

The corner posts 710 can be made of any suitable material, such as, for example, cardboard or a plastic. Corner posts 710 may be solid or hollow.

The corner posts 710 may be any suitable height, such as, for example, the height 520 of the domain space 500 or a percentage of the height 520 of the domain space 500, such as, for example, 90% of the height, 80% of the height, 70% of the height, 60% of the height, 50% of the height, 40% of the height, 30% of the height, 20% of the height, 10% of the height, or 5% of the height.

The corner posts 710 may extend the entire length 540 of the domain space 500 or a percentage of the length 540 of the domain space 500, such as, for example, 90% of the length, 80% of the length, 70% of the length, 60% of the length, 50% of the length, 40% of the length, 30% of the length, 20% of the length, 10% of the length, or 5% of the length.

The corner posts 710 may extend the entire length width 530 of the domain space 500 or a percentage of the width 530 of the domain space 500, such as, for example, 90% of the width, 80% of the width, 70% of the width, 60% of the width, 50% of the width, 40% of the width, 30% of the width, 20% of the width, 10% of the width, or 5% of the width.

As shown in FIGS. 9-10, a tray 730 and a hood 740 may be used to contain the unit load 700. The tray 730 and the hood 740 may be made of any suitable material, such as, for example, plastic and cardboard.

The hood 740 may contain a central panel and four side panels that cover each side of the unit load 700. The hood 740 side panels may come in contact with the tray 730. The hood 740 side panels may be the height 520 of the domain space 500 or a percentage of the height 520 of the domain space 500, such as, for example, 90% of the height, 80% of the height, 70% of the height, 60% of the height, 50% of the height, 40% of the height, 30% of the height, 20% of the height, 10% of the height, or 5% of the height.

FIG. 10 shows a domain space 500 comprising secondary packages 400 that are contained by a tray 730, corner posts 710, a hood 740, and wrapping 720. The wrapping 720 may be any suitable material, such as, for example, shrink wrap, non-shrinking plastic film, stretch film, and paper, as shown in FIGS. 10 and 12. The wrapping 720 may bridge the two unit loads connecting the upper unit load to the lower unit load. The wrapping material may exhibit parameters, such as, for example, initial modulus, reloading modulus, yielding stress, and failure strain. The user may further input other parameters, such as, for example, the number of wraps and the wrap profile. The wrap profile may comprise wrapping the unit load from top to bottom, wrapping the unit load from bottom to top, wrapping the unit load from center to top, and wrapping the unit load from center to bottom.

Alternatively, as shown in FIG. 11, the secondary packages 400 may be contained by a panel 750, a strap 760, or a combination of the panel 750 and the strap 760. The panel 750 may cover between 10% and 100% of a face of the unit load 700. The panel 750 may cover an area equivalent to or a fraction of the area determined by the length 540 times the height 520 of the domain space 500 or to the width 530 times the height 520 of the domain space 500.

The one or more straps 760 may be made of any suitable material. The straps 760 may encircle the entire outer perimeter of the unit load.

FIG. 12 shows two pallets, each with a unit load 700, wherein a second pallet 555 is placed on top of a pallet 550. The weight of the second pallet and unit load 700 may be supported by the corner posts of the pallet 550.

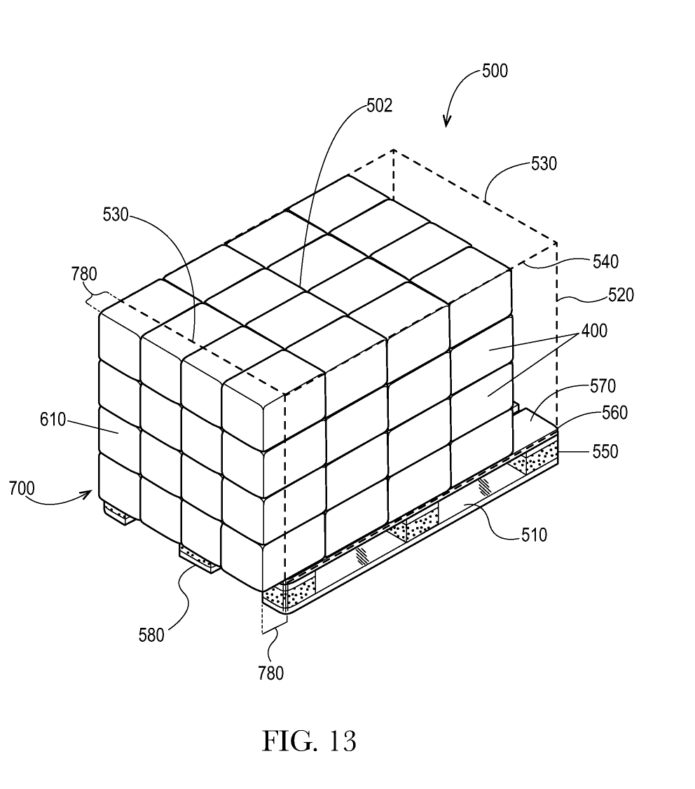

FIG. 13 shows a unit load 700 that has shifted beyond the domain space 500 to create overhang 780 and a shift in the center of mass of the unit load.

The center of mass may be calculated by:

$$R = \frac{1}{M} {\sum }_{i = 1}^{n} {m}_{i} {r}_{i}$$

where i=1, 2, . . . , n is the element number, mᵢ is the mass of element i, rᵢ is the coordinates of element i, M is the total mass of all elements, and R is the coordinates of mass center. The elements may be a portion of a primary package, a whole primary package, a portion of a secondary package, a secondary package, a plurality of primary or secondary packages, and a plurality of primary and secondary packages.

The distance between any two points in the domain space may be calculated by:

D=\sqrt{(l₁−l₂)²+(w₁−w₂)²+(h₁−h₂)²}

where D equals the distance, l refers to the length of the domain space, w refers to the width of the domain space, h refers to the height of the domain space, (l₁, w₁, h₁) represent a first location within the domain, and (l₂, w₂, h₂) represent a second location within the domain space. The distance equation may be used to determine a shift in the location of the center of mass before and after a simulation or to determine the location of a center of mass versus one or more reference points.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A method of simulation, comprising:
representing a plurality of packages;
representing a domain space;
configuring the plurality of packages within the domain space;
containing the plurality of packages to create a unit load;
simulating conditions on the unit load; and
determining the stability of the unit load.

2. The method of claim 1, wherein the plurality of packages comprises a plurality of primary packages, a plurality of secondary packages, or combinations thereof.

3. The method of claim 2, wherein the plurality of primary packages are deformable.

4. The method of claim 2, wherein configuring the plurality of packages within the domain space comprises configuring the secondary packages and the primary packages and wherein the primary and secondary packages are of different sizes and shapes.

5. The method of claim 1, wherein configuring the plurality of packages within the domain space comprises configuring interlocking packages.

6. The method of claim 1, wherein containing the plurality packages to create a unit load comprises containing the packages by a restraining element selected from the group consisting of a wrapping material, an enclosing panel, one or more corner posts, a tray, a hood, a strap, and combinations thereof.

7. The method of claim 1, wherein containing the packages within the domain space may include inputting parameters for the wrapping material selected from the group consisting of initial modulus, reloading modulus, yielding stress, failure strain, and combinations thereof.

8. The method of claim 1, wherein simulating conditions on the unit load comprises inputting one or more conditions selected from the group consisting of a magnitude of a force, a direction of a force, the number of times a unit load is exposed to a force, a force pattern, the angle of the unit load when being exposed to a force, the location of the unit load exposed to the force, and combinations thereof.

9. The method of claim 1, wherein simulating conditions on the contained unit load further comprises simulating stress over time on the unit load, and inputting frictional behavior between any two packages including static forces and dynamic behavior forces.

10. The method of claim 1, wherein determining the stability of the unit load comprises determining a shift in the location of the unit load, determining a shift in the location of a package, determining overhang for the unit load beyond the domain space, and determining overhang for a package beyond the domain space.

11. The method of claim 1, wherein the domain space consists of a first pallet with a unit load and a second pallet with a unit load contained together.

12. A method of simulation, comprising:
representing a plurality of packages;
representing a domain space;
configuring the plurality of packages within the domain space;
simulating conditions on the plurality of packages as a unit load; and
determining the stability of a package.

13. The method of claim 12, wherein the plurality of packages comprise of secondary packages.

14. The method of claim 13, wherein the secondary packages comprise a primary package and wherein the primary package comprises a good in the form of particles.

15. The method of claim 13, wherein the secondary packages comprise a primary package and wherein the primary package comprises a consumer unit.

16. The method of claim 12, wherein configuring the plurality of packages within the domain space further comprises configuring interlocking packages.

17. The method of claim 12, wherein simulating conditions on the unit load comprises inputting one or more conditions selected from the group consisting of a magnitude of a force, a direction of a force, the number of times a unit load is exposed to a force, a force pattern, the angle of the unit load when being exposed to a force, the location of the unit load exposed to the force, and combinations thereof.

18. The method of claim 13, wherein the simulation further comprises simulating relaxation of the materials of the packages and creep of the materials of the packages.

19. The method of claim 1, wherein determining the stability of the packages comprises determining a shift in the location of the unit load, determining a shift in the location of a package, determining overhang for the unit load beyond the domain space, and determining overhang for a package beyond the domain space.

20. The method of claim 15, wherein the consumer unit is an absorbent article.
